(19) United States
(12) Patent Application Publication
(10) Pub. No.: US 2014/0379746 A1
(43) Pub. Date: Dec. 25, 2014

(54) SYSTEM AND METHOD FOR PROVIDING TOPIC CLUSTER BASED UPDATES

(71) Applicant: Yahoo! Inc., Sunnyvale, CA (US)

(72) Inventors: Liang-Yu (Tom) Chi, San Francisco, CA (US); Su-Lin Wu, San Carlos, CA (US)

(21) Appl. No.: 14/479,501

(22) Filed: Sep. 8, 2014

Related U.S. Application Data
(63) Continuation of application No. 12/910,911, filed on Oct. 25, 2010.

(51) Int. Cl. G06F 17/30

(52) U.S. Cl. CPC G06F 17/3064; G06F 17/30705
USPC 707/767

(57) ABSTRACT

The present invention is directed towards a method and system for providing a recommendation set. The method and system includes determining various topic clusters from single topic clusters. The method and system further includes identifying various topic clusters for an identified single topic cluster and providing recommendations from the various topic clusters via web updates.

### CROSS-REFERENCE TO RELATED APPLICATION

The present application is a continuation of and claims priority to U.S. patent application Ser. No. 12/910911, filed Oct. 23, 2010, entitled, SYSTEM AND METHOD FOR PROVIDING TOPIC CLUSTER BASED UPDATES, which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention described herein generally relates to recommendation systems and more specifically to systems and methods for providing relevant updates based on clustering of topics.

### BACKGROUND OF THE INVENTION

The amount of available digital information has dramatically increased with the wide spread proliferation of computer networks, the Internet and digital storage devices. With such increased amounts of information has come the need to more efficiently determine the interests of a user to present or otherwise suggest additional relevant content.

There has been a growing trend of social interactivity on the Internet. Social interactivity provides for information sharing, user-centered design and World Wide Web collaboration. Examples of social interactivity on the Internet include web-based communities, social-networking sites, video-sharing sites, wikis and blogs. Web sites embracing social interactivity have become a part of mainstream culture and have created new embodiments of web content. The growing trends of social interactivity have also made the Internet a setting for users to share their views and interests, incorporating the Internet into their daily lives.

Often a user may search for content items related to their interests. A search for content items may be supplemented with recommendation systems. Recommendation systems may provide additional content items that are similar to the content items a user is searching for. For example, recommendation systems may be employed by search service providers to help suggest items similar to those previously viewed or saved. Current recommendation systems may track user activities or profiles to determine a relationship among a group of users. Members of the group of users may be provided with recommendations based on the interests from each group member. In such systems, content item suggestions may be based on the searches and history from other members of the group.

Current systems fail to capture the entire scope of a user's interests. The user's interest in a specific entity is often times an instance of interest in a larger concept or set of concepts of which the specific entity is part. For example, a user may be interested in a particular baseball team and a recommendation service may suggest merchandise affiliated with that particular baseball team that the user is showing interest in. The user, however, may be more broadly interested in baseball teams in a certain division and other teams belonging to that division in a certain region. Alternatively, the user may also be interested in sports highlight video for the particular baseball team. Current recommendation systems provide recommendations based on searches from other similar users and fail to determine the actual interests of the user.

Another shortcoming of the current recommendation systems is that they provide recommendations from limited genre types. For example, a search for tires may include a recommendation for content items limited to tire companies and retailers. The current recommendation systems fail to provide content items from alternative sources of content provided from other genres. A user is not provided with a view of recommendations related to the user's interest from a plurality of content sources and genres. Such systems provide a limited scope of types of content items to the user for a general search.

### SUMMARY OF THE INVENTION

The present invention provides a method, system and computer program product for providing a recommendation set. The method according to one embodiment of the present invention includes generating one or more clusters comprising a group of seed topics, determining an overall topic for a given one of the clusters and determining a neighbor topic for the overall topic, the neighbor topic associated with the overall topic. The method further comprises identifying a seed topic on the basis of an observed user activity to identify a given overall topic for the identified seed topic, identifying one or more given neighbor topics on the basis of the given overall topic, accessing a data store on the basis of both the given overall topic and the one or more given neighbor topics to retrieve a recommendation set that includes links to one or more content items from the data store and transmitting the recommendation set to a user via an update message.

The method according to the presently claimed invention further comprises modifying the one or more clusters on the basis of a user profile and determining overall topics from the modified clusters. Accessing the data store may comprise retrieving links to one or more content items selected from the set of content items including headlines, instant messages, syndication feeds, blog messages, forum messages, social networking information, links, advertisements and multimedia content. The update may comprise propagating a message through a social network. The generated clusters may be comprised of clusters understandable by the user according to user knowledge level. The method further comprises receiving user feedback associated with the recommendation set. The user may receive the update message as a subscription service.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a computing system for providing recommendation updates according to an embodiment of the present invention;

FIG. 2 illustrates a computing system for providing recommendation updates according to another embodiment of the present invention;

FIG. 3 illustrates a flowchart of a method for providing recommendation updates according to an embodiment of the present invention;

FIG. 4 illustrates a flowchart of a method for providing recommendation updates based on user profiles according to an embodiment of the present invention;

FIG. 5 illustrates a diagram representing a group of topic clusters according to an embodiment of the present invention;

FIG. 6 illustrates a recommendation set according to an embodiment of the present invention; and

FIG. 7 illustrates a recommendation set in an alternative format provided to a device according to an embodiment of the present invention.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

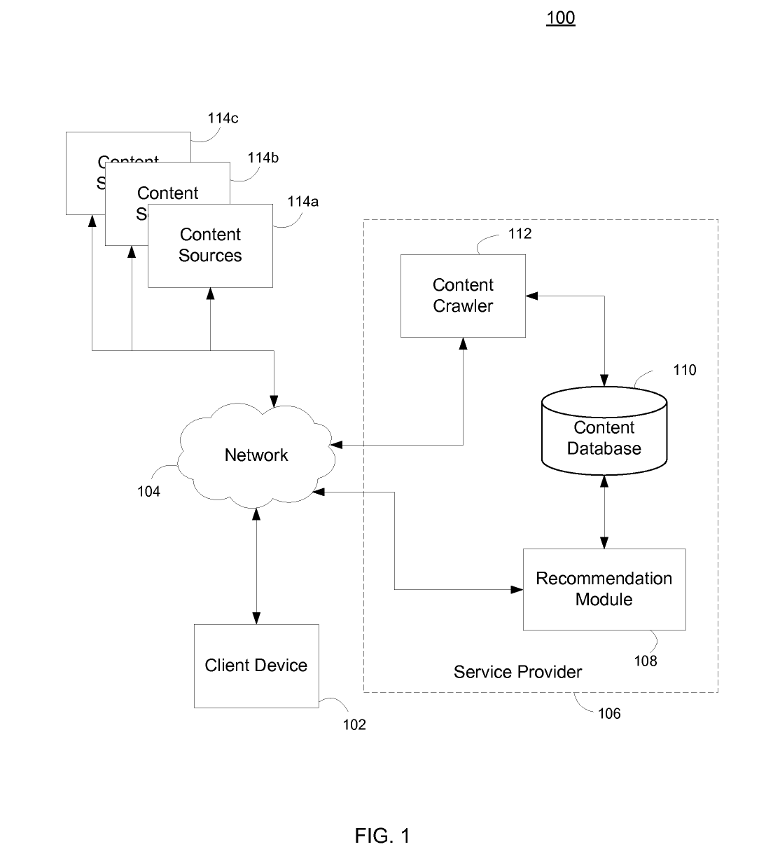

FIG. 1 illustrates one embodiment of a system 100 for providing recommendation updates that includes a client device 102, network 104, service provider 106 and content sources 114a, 114b and 114c (collectively referred to as 114). Service provider 106 may comprise recommendation module 108, content database 110 and content crawler 112.

Client device 102 may comprise a desktop personal computer, workstation, terminal, laptop, personal digital assistant (PDA), cell phone, or any computing device capable of connecting to a network. Client device 102 may also comprise a graphical user interface (GUI) or a browser application provided on a display (e.g., monitor screen, LCD or LED display, projector, etc.). Network 104 may be any suitable type of network allowing transport of data communications across thereof. In a one embodiment, the network may be the Internet, following known Internet protocols for data communication, or any other communication network, e.g., any local area network (LAN), or wide area network (WAN) connection.

Service provider 106 may comprise one or more processing components disposed on one or more processing devices or systems in a networked environment. The Service provider 106 may operate in a manner similar to known search engine technologies, but with the inclusion of additional processing capabilities describes herein. Client device 102 may provide search queries and user browsing activities to service provider 106. In an alternative embodiment, a third party provider (not illustrated) may collect the search queries or user browsing activities from client device 102 and forward them to provider 106.

Search queries may be manually entered by the user, generated from a click on a link, or automatically generated from observed user activity. In one embodiment, the service provider 106 is operative to receive a search query and process the query to generate search results for transmission to the client device 102 across the network 104. In an alternative embodiment where search queries are generated from user activity, service provider 106 is operative to receive the user activity and analyze the activity to form search queries. User browsing activity may be collected for analysis periodically or in response to an event. From the analysis, search queries may be determined. Automatically generated search queries and user activities may be collected for transmission to the service provider 106. In some embodiments, automatically generated queries may be a selectable feature that a user configures or a service a user may be able subscribe to. In another embodiment, the automatically generated queries may be created by the third party provider that receives and processes user activities.

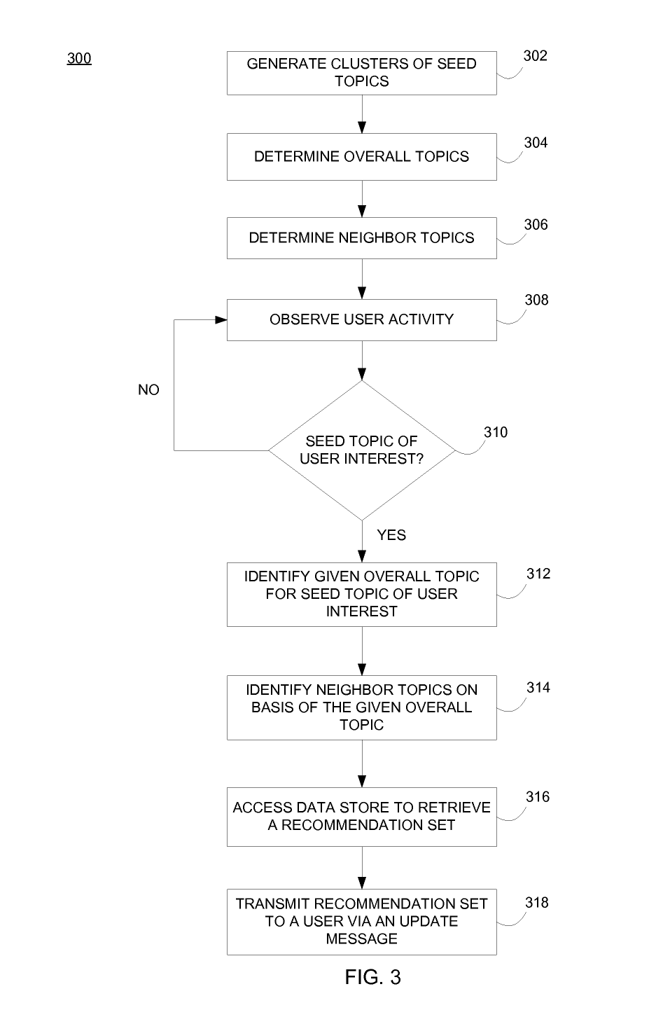

Service provider 106 may utilize search queries to determine seed topics. As used herein, the term “seed topic” refers to a topic of user interest and may relate to a specific entity and may stem from a broader overall topic. On the basis of the broader overall topic, service provider 106 may locate neighbor topics or contents of interest to the user. Methods for determining and identifying topics are described in further detail below with respect to the description of FIG. 3-5. From the neighbor topics determined for a given overall topic, service provider 106 may provide content recommendations to client device 102.

Client device 102 receives recommendations from service provider 106 through network 104. Service provider 106 retrieves and provides to client device 102 content items or links to content items by recommendation module 108 from content database 110. Content crawler 112 is operable to retrieve content items or links to the content items from a plurality of content sources 114. Content sources 114 may comprise any content or outlet of content including but not limited to news, products, services, advertisements, instant messages, blogs, syndication feeds, forums, social networking sites, email and multimedia content. Content items or links to the content items gathered by content crawler 112 are populated into content database 110. Content recommendations retrieved from content database 110 may be presented to client device 102 as search results on a search results page or as a recommendation set on a recommendation page, as is illustrated in greater detail herein.

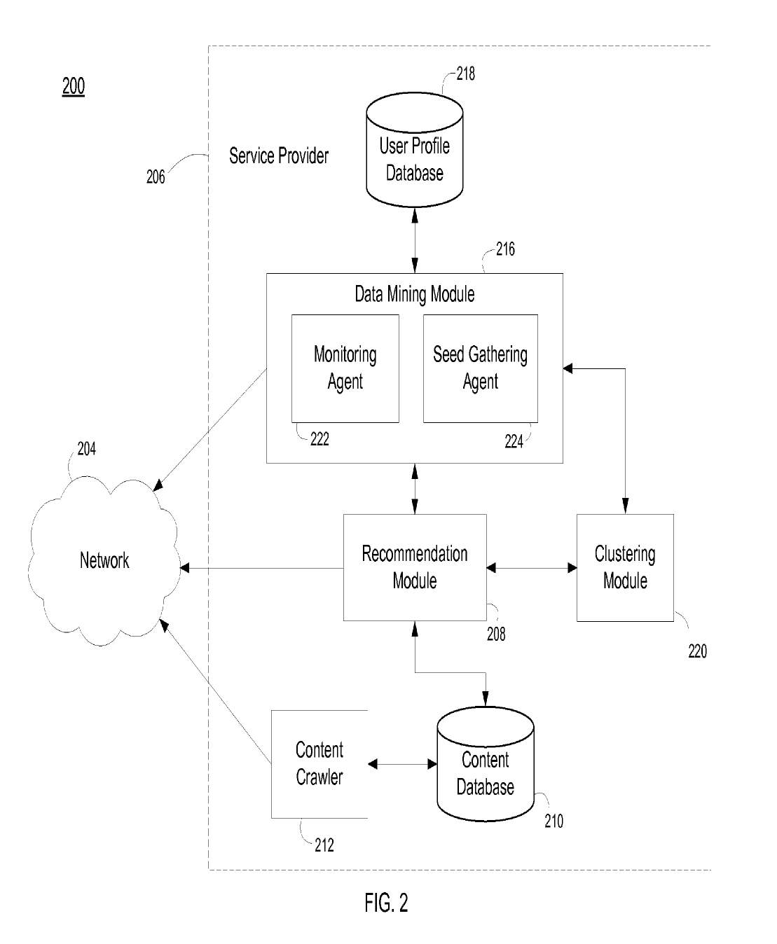

FIG. 2 describes in further detail one embodiment of a system for providing recommendations to client device. FIG. 2 illustrates, in an alternative embodiment, a system 200 including network 204 and service provider 206. Service provider 206 comprises recommendation module 208, content database 210, content crawler 212, data mining module 216, user profile database 218 and clustering module 220.

Service provider 206 receives search queries or user browsing activities from client device across network 204. Data mining module 216 collects a variety of user information from client device that may include, but is not limited to, user preferences, user knowledge level, user active subscriptions and recent user purchases. In one embodiment, collected information may include social networking, blogging, subscription, email and instant messaging activities. Data mining module 216 further includes monitoring agent 222 and seed gathering agent 224. Monitoring agent 222 observes user browsing or searching activities to identify a given user's interest.

In one embodiment, data mining module 216 may generate search queries from a user's browsing activities or from a combination of the user's browsing activities and other information collected by the data mining module 216. In an alternative embodiment, users of the recommendation system may install a downloadable agent onto client device. The agent may monitor the user's activity without requiring the user to log on to a specific web page or site. The agent software communicates and sends user activity information to monitoring agent 222. In one embodiment, monitoring agent 222 follows an item a user shows interest in and identifies the item as a seed topic to provide recommendations for the user. A seed topic of user interest may be determined based on a threshold of time a user spends on a certain activity. In another embodiment, the user may specify a seed topic for which the user desires content recommendation.

In one embodiment, seed gathering agent 224 may determine seed topics for the given user from user browsing and searching activities observed by monitoring agent 222. Seed gathering agent 224 may collect the user's interests, activities or search queries and extract them into seed topics. Terms, words or phrases may be extracted from search queries or viewed content items into the seed topics. Seed topics may be forwarded to clustering module 220 for clustering. In an alternative embodiment, both the determining and gathering of seed topics may be performed by seed gathering agent 224.

User information or activity may also be used by data mining module 216 to create user profiles for a given user, which may be stored in user profile database 218. Profile information stored in database 218 may include, but is not limited, to gender, race, age, user activity/browsing history, shopping interests, expertise information, occupation, educational background, subscriptions, geographic location and search query history. Information in the user profiles may also include the given user's likes and dislikes.

Clustering module 220 receives one or more seed topics and may group them into clusters, in which a given cluster may represent a group of seed topics related to a common theme or category. Clustering module 220 is operative to determine an overall topic for a given one of the clusters. In addition, neighbor topics, which are associated with the overall topic, may also be determined by clustering module 220 for a given overall topic. Clustering module may store one or more topic maps defining the seed, overall and neighbor topics.

Recommendation module 208 may select and identify a seed topic on the basis of an observed user activity from monitoring agent 222 to identify a given overall topic. Recommendation module 208 may also identify one or more given neighbor topics on the basis of the given overall topic for the cluster to which the identified seed topic belongs. Content database 210 may comprise content items or links associated with a plurality of topics. Upon identifying the given overall topic and the given neighbor topic, the recommendation module 208 may access content database 210 to retrieve a recommendation set of content items or links to content items associated with the given overall topic or the given neighbor topic.

The content items or links in database 210 may be populated from content sources 114 by content crawler 212. Content crawler 212 maybe operative to gather content items or links based on a variety of factors including but are not limited to relevancy, popularity, trends, targeted and contemporary content. In one embodiment, the recommendation module 208 retrieves content items or links to the content items from database 210 to create a recommendation set. In an alternative embodiment, recommendation module 208 retrieves content items or links directly from content sources. A recommendation set may be comprised of a plurality of content items from a plurality of sources. For example, a given recommendation set may contain product advertisements, news articles, messages on a social networking site and multimedia content items. In another embodiment, recommendation module 208 may also retrieve user profiles from user profile database 218 in determining recommendation sets for users. Information in the user profiles may be used to determine or customize a recommendation set specifically for each user.

The retrieved recommendation set may be transmitted to client device via an update message. The update message may be provided in an email, pop-up window, instant message, SMS message, message on a social networking site, or any other communication means to a client device. The present recommendation system includes retrieving recommendation sets for content based on a user's interest, which is described in further detail below.

FIG. 3 presents a flowchart illustrating one embodiment of a method 300 for providing a recommendation set to a client according to an embodiment of the present invention. The method of FIG. 3 may be executed in the systems of FIGS. 1 and 2 or any other suitable processing environment. Clusters of seed topics may be generated from the user's interests, online activities or search queries, step 302. In one embodiment, user online activities may include social networking, blogging, subscription, email and instant messaging activities. A determination is made to determine if the seed topics are members of an existing cluster group. In a simplistic embodiment, a cluster group may be defined as one seed topic, thus a check may fail and a new group may be created for a given seed topic. In more sophisticated embodiments seed topics may be grouped according to subject matter, according to seed topic similarity, etc. That is, a plurality of related seed topics may be grouped as a logical container. For example, the topics “New York City”, “NYC subway” and “Empire State Building” may be grouped as a single category “New York City.” Rules defining the grouping of seed topics may be modified by a system administrator, site developer or any person responsible for site maintenance. Alternatively, an adaptable algorithm may be employed to passively examine global search trends and formulate rules based upon global search history.

After the seed topic clusters are generated, overall topics may be determined for a given one of the clusters, step 304, and a neighbor topic associated with the overall topic is determined, step 306. The method further includes observing user activity, step 308. Observing user activity may comprise retrieving search queries or user activity from a client device. From the observed user activity, a seed topic may be identified as an area of interest a user may want to receive content recommendations, step 310. If there are no seed topics a user is interested in, user activity may be continuously monitored.

If there is a seed topic of user interest, step 310, a given overall topic is identified for the identified seed topic of user interest on the basis of the observed user activity. The given overall topic may be identified from a topic map, and one or more given neighbor topics may be identified on the basis of the given overall topic, step 314. The one or more given neighbor topics may also be identified from the topic map.

A data store is accessed on the basis of both the given overall topic and the one or more given neighbor topics to retrieve a recommendation set that includes links to one or more content items from the data store, step 316. Accessing the data store on the basis of both the given overall topic and the one or more given neighbor topics comprises retrieving links to, or related to, content from the clusters or concepts associated with the given overall topic and given neighbor topics identified in a topic map. In some embodiments, accessing the data store includes accessing the data store only on the basis of the given overall topic. In another embodiment, accessing the data store includes accessing the data store only on the basis of the one or more given neighbor topics.

Step 318 includes transmitting the recommendation set to the user via an update message. The recommendation set comprises links to content items associated with the given overall topic and the one or more given neighbor topics. The update message may be presented to the user on a recommendation page or a search results page. In one embodiment, the recommendation set may be transmitted to a mobile phone or wireless device. The update messages containing the recommendation set may be in the form of a social media update, SMS message, email, popup, browser alert, or instant message.

Updates may be provided to the user on demand or scheduled to be delivered upon a specified time. On demand updates may be suitable for retrieving recommendations from content links stored in a content database. In other embodiments, users may have the option of obtaining recommendations from content sources in real-time. Real-time recommendation retrievals may provide the most contemporary content. Scheduled recommendations may include links from both real-time content (from content sources) and content stored in content database. In another embodiment, updates may be delivered to a user on a periodic basis determined by the user or recommendation service provider.

In one embodiment, a user may create an online account to subscribe for recommendation updates from a recommendation service provider. The user may receive update messages as a feature of the recommendation service. Recommendation sets may be aggregated onto a user account and delivered to the user. The account may maintain a user's recommendation sets for subsequent retrieval. In another embodiment, the recommendation service may allow users to register and link accounts from other services such as email, social networking sites and blogs to the recommendation service, where the recommendation service may send recommendation updates to one or more of the linked accounts. According to another embodiment, the recommendation service may further monitor activity of the linked accounts. Monitored activity of the linked accounts may be used in identifying seed topics or creating user profiles.

A user may request the recommendation service to track or follow a topic of interest in the background while the user performs other tasks on their computing or mobile device. In one embodiment, the recommendation service may be set to retrieve recommendations while the user is away or busy. The user may receive recommendation updates at a scheduled time or on a periodic basis. In another embodiment, a user may be able to log on to the recommendation service to review their recommendation updates. Alternatively, the user may have registered a linked account, as described above, or a cellular phone to automatically receive update messages comprising recommendation sets.

In one embodiment, the recommendation service may be able to determine a geographical location of the user via a user's Internet Protocol (IP) address, Global Positioning System (GPS), or geolocation technology. In another embodiment, a user may simply specify their geographical location. Providing a geographical location of the user enables recommendations to be tailored towards a specific geographical area for increased relevancy and usefulness to the user.

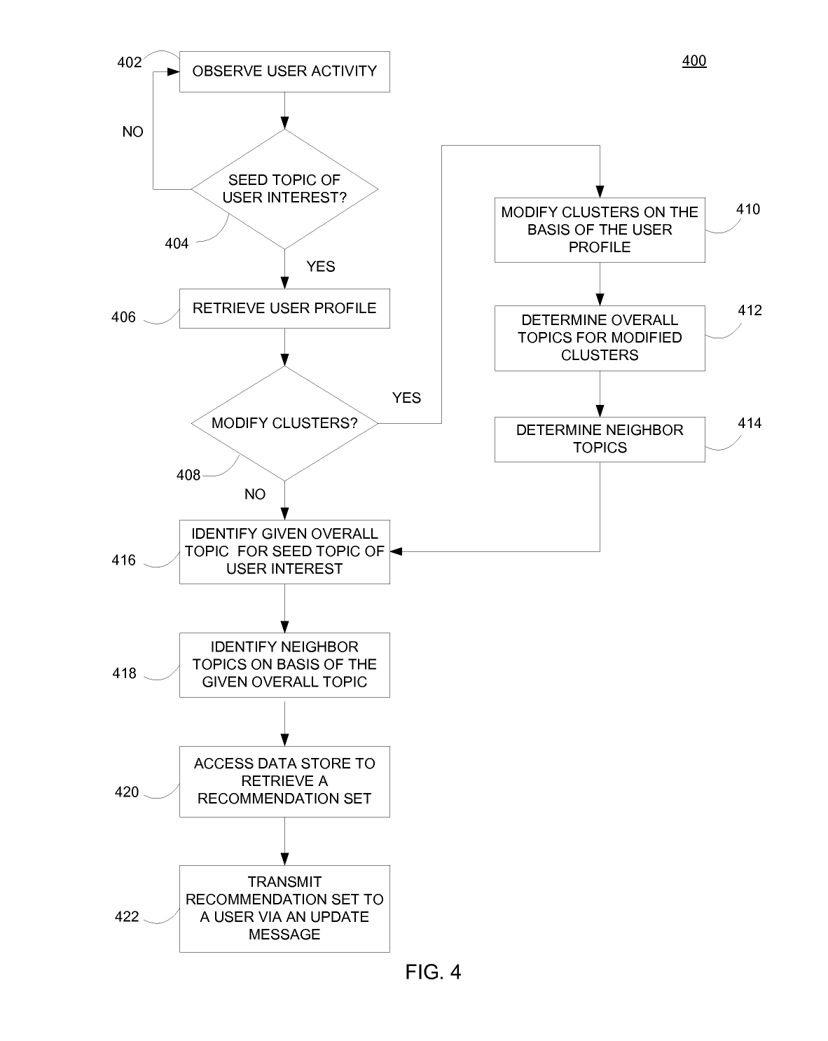

FIG. 4 illustrates another embodiment, whereby providing a recommendation set includes modifying clusters on the basis of a user profile. FIG. 4 presents a method 400 according to an embodiment of the present invention. The method initialize with the observance of user activity, step 402. Observing user activity may comprise retrieving search queries or user activity from a client device. From the observed user activity, a seed topic may be identified as an area of interest a user may want to receive content recommendations, step 404. If there are no seed topics a user is interested in, user activity may be continuously monitored.

If a seed topic of user interest exists, a user profile is retrieved, step 406, which may be from a user profile database. A check is made to determine from the user profile whether existing clusters need to be modified to suit the user's preferences, step 408. If the check at step 408 evaluates to true, processing proceeds with step 410, which is operative to modify one or more clusters on the basis of the user profile. For example, the music group Cascada may be clustered under a “Euro Dance” cluster for a user identified as a disc jockey. For a casual music listener, however, Cascada may be clustered under a “Dance Music” cluster. In most cases, a casual listener is unable to distinguish “Euro Dance” from “Dance Music.” In some situations, fine granular clustering may even confuse a user's understandability of the clusters or cluster topics. A clustering module may cluster topics according to various levels of granularity depending on the user's preference. One or more overall topics may be determined for the modified clusters, step 412 and one or more neighbor topics associated with the overall topics of the modified clusters may also be determined, step 414.

User profiles stored in a database may be used to shape clusters according to a user's knowledge level. Cluster granularity may be determined from information contained in the user profiles. In one embodiment, language used in prior searching activities may be stored in the user profiles and used to determine the level of expertise or knowledge of a user towards specific topics. Some users may be suited for finer granularity topic clusters while other users may not require finer granularity clusters. Users may be categorized as one of amateur, average, advanced, or expert level users. Providing for customizable clustering tailors the topic clustering according to the amount of granularity necessary for user understandability and functionality.

Regardless of the result of step 408, however, processing continues with the identification of a given overall topic for the seed topic of user interest, step 416. The given overall topic may be identified according to the embodiments described above in modifying topic clusters. In a next step, one or more given neighbor topics are identified on the basis of the given overall topic, step 418, and a data store is accessed on the basis of the given overall topic and the one or more given neighbor topics to retrieve a recommendation set that includes links to one or more content items from the data store, step 420. The next step, step 422, includes transmitting the recommendation set to the user via an update message.

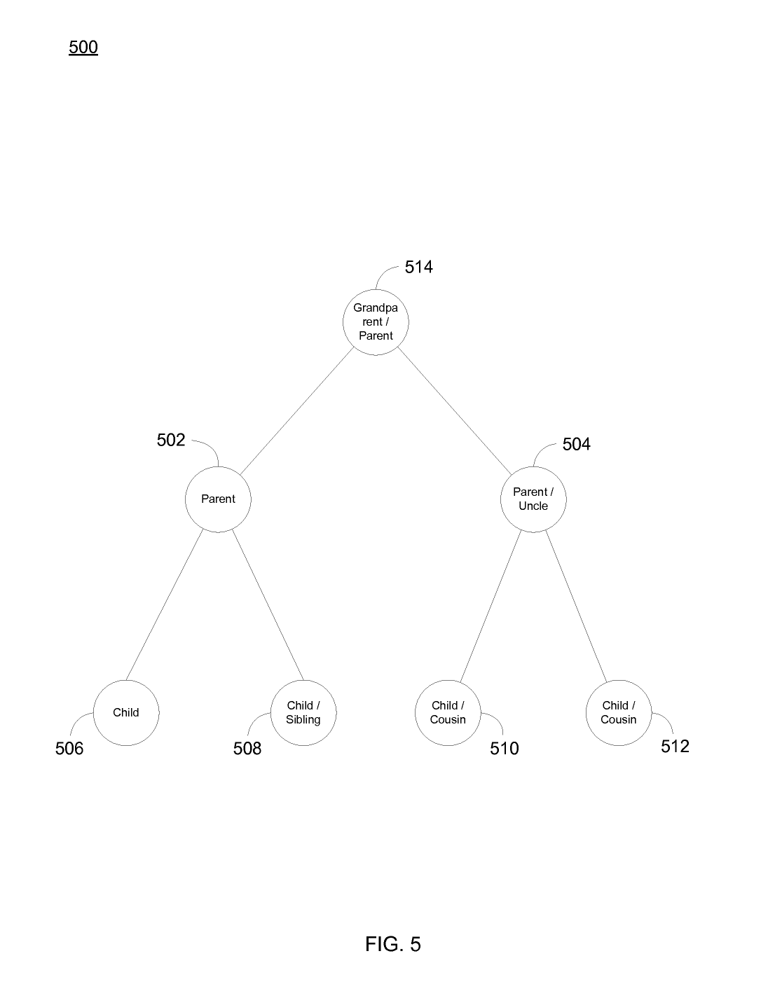

Referring to FIG. 5, the diagram illustrates a topic map 500 according to one embodiment of the present invention that comprises a plurality of clusters or concept nodes. Node 506 illustrates a “child” node and may exemplify a seed topic. For example, node 506 may represent “New York Yankees” merchandise. An overall topic determined for node 506 may be “parent” node 502. Parent node 502 may represent, more broadly, the “New York Yankees.” In another embodiment, the overall topic for node 506 may be “grandparent” node 514, representing “New York Baseball.”

For example, node 508 may represent “New York Yankees News” and is associated with overall topics 502 or 514. It may then be determined that “sibling” node 508, is a neighbor topic for seed topic 506. In another embodiment, “uncle”/parent node 504 may represent the “New York Mets” and may be determined as a neighbor topic for seed topic 506. In yet another embodiment, “cousin” node 510 may represent “New York Mets Merchandise” while cousin node 512 may represent “New York Mets News,” and both nodes may be determined as neighbor topics for seed topic 506. While in this example, nodes 508, 510 and 512 represent neighbor topics for node 506, each of the child nodes 506, 508, 510 and 512 represent neighbor topics from one another. Parent nodes 502 and 504 may be determined as neighbor topics from each other along with their child nodes. Further, parent node 502 represents an overall topic for nodes 506 and 508, uncle/parent node 504 represents an overall topic for nodes 510 and 512, and grandparent node 514 represents an overall topic for each of the parent and child nodes. Topics determined in topic map 500 may be stored in a clustering module and used to identify overall or neighbor topics for a given seed topic. Each level of nodes, from grandparent node to child node, represents a granularity level. Generally, traversing upwards provides broader topics while traversing downwards presents narrower topics.

In one embodiment, a topic map may be replicated for each user and re- determined according to a given user's profile. In an alternative embodiment, overall and neighbor topics in a topic map may be determined with best-effort finest granularity and identified based on user profile. For example, a user may be recognized as desiring a finer granularity of clustering and identifies parent node 502 as an overall topic. For a default user, however, grandparent node 514 may be identified as an overall topic. Parent node 502 may exist as an overall topic for a default user but may be omitted in the identification of an overall topic for the sake of simplicity to the user not requiring finer granularity clusters.

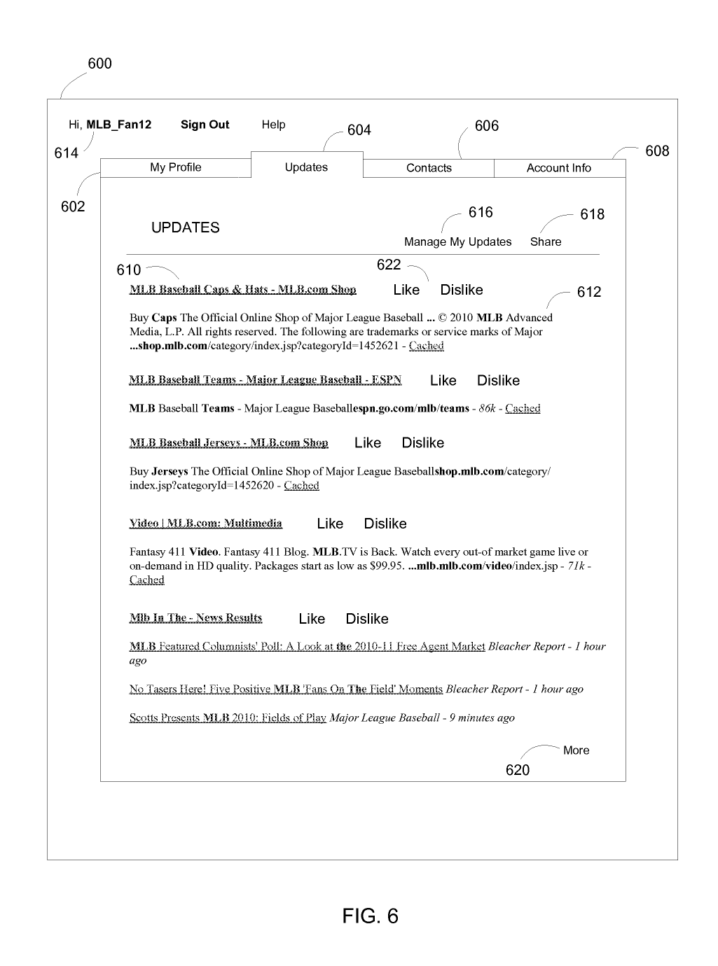

FIG. 6 presents an exemplary screen diagram illustrating one embodiment of a recommendation set. Recommendation service page 600 displays a view of a user logged in to their recommendation service account. Recommendation service page 600 displays an updates tab 604 containing a recommendation set for a given seed topic. From the earlier example relating to baseball topics, a user may be currently browsing a web site of the “New York Yankees” baseball team and decides to purchase a T-shirt from that web site. The recommendation system of the present invention may identify from the overall and neighbor topics that the user may be interested in baseball caps or jerseys. Recommendations may include content items other than baseball merchandise. Additional topics recommended by the recommendation system may include baseball team web sites, baseball videos and baseball news. The user is capable of being provided with broad-based recommendations. In another embodiment, a user may be provided with a recommendation update including content from updates tab 604 without having to log on to the recommendation service page 600. In yet another embodiment, the recommendation set may be presented as an email, popup window, instant message, SMS message or a message on a social networking site.

A recommendation set comprises content links as illustrated by link 610. Each link may include a link description 612. Profile tab 602 allows a user to access and modify their profile settings. Profile tab 602 may also be operable to link accounts from other services with the recommendation service and provide communication preferences for receiving updates. Contacts tab 606 may allow a user to add or edit contacts. Account info tab 608 allows for display of a user's account information such as billing info, account name, address, phone number, etc. The recommendation service page 600 displays the username 614 of the account. A user is able to manage updates via the “manage my updates” link 616. Managing updates may include sorting recommendation sets, saving recommendation sets, and scheduling recommendation set updates.

A share link 618 allows users of the recommendation service to share recommendation sets with contacts. A more link 620 may provide additional recommendation links for a current seed topic, which may also provide users with the option to view recommendation sets for other seed topics. Users receiving recommendation sets may provide user feedback for each recommended link via like or dislike links 622. User feedback may be provided to the recommendation system to shape a user's profile and modify future recommendation sets. In one embodiment, the user feedback may dynamically update a current recommendation set the user is viewing.

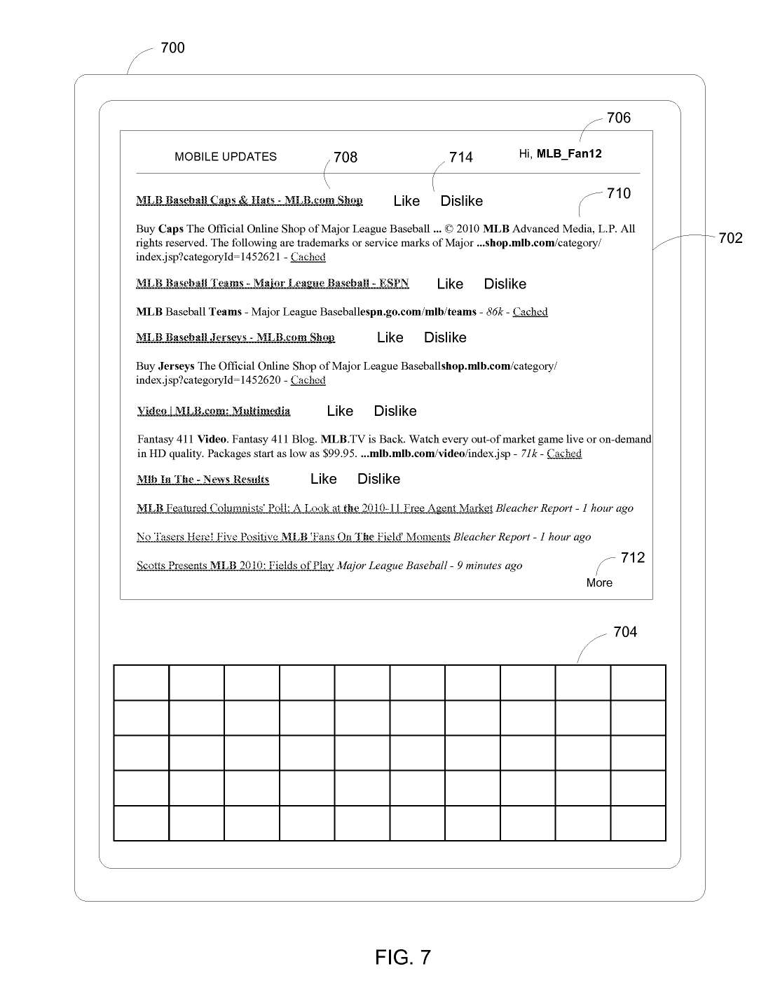

FIG. 7. presents a screen diagram illustrating another embodiment of the recommendation set. Device 700 is operative to receive and display an update message comprising a recommendation set on recommendation page 702. Device 700 may be any mobile or portable computing device operable to connect to a network and may comprise input keys 704, which may be a physical keypad or a touch screen keypad on device 700. Page 704 displays a recommendation set as “Mobile Updates.” In one embodiment, recommendation updates displayed on device 700 may be provided to the user as an alert or message. The recommendation page displays username 706 of the user receiving the alert or message and, according to one embodiment, alerts or messages containing recommendation sets may be sent according to communication preferences from a recommendation service account mentioned above. A recommendation set comprises content links as illustrated by content link 708. Each link capable of being navigated to by device 700 and includes a content description 710. “More” link 712 may provide additional recommendations to the user. A given content link 708 may include “Like Dislike” links 714 to provide user feedback to the recommendation service.

FIGS. 1 through 7 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method implemented on at least one computing device each of which has at least one processor, storage, and a communication platform connected to a network for content recommendation, the method comprising:
determining a topic of interest based on a user's online activities;
obtaining a profile of the user;
generating a cluster of topics based on the determined topic of interest and the profile of the user, wherein the cluster of topics include the determined topic of interest and one or more neighbor topics that share a common theme with the determined topic of interest;
determining an overall topic of the cluster of topics and at least one of the one or more neighbor topics; and
providing content recommendation to the user including a first piece of content related to the overall topic and a second piece of content related to the at least one neighbor topic.

2. The method of claim 1, wherein at least one of the first and second pieces of content is determined based, at least in part, on locality of the user.

3. The method of claim 1, wherein
the profile of the user comprises the user's knowledge level with respect to the determined topic of interest; and
a granularity of the cluster of topics is adjusted based, at least in part, on the user's knowledge level with respect to the determined topic of interest.

4. The method of claim 3, wherein the user's knowledge level with respect to the determined topic of interest is determined based on prior searching activities of the user.

5. The method of claim 1, wherein
the cluster of topics are arranged in a hierarchy;
the overall topic of the cluster is determined by traversing up the hierarchy from the determined topic of interest; and
the at least one neighbor topic is determined by traversing up and traversing down the hierarchy from the determined topic of interest.

6. The method of claim 1, wherein the content recommendation is provided to the user through a social network.

7. The method of claim 1, wherein the content recommendation is provided to the user as a subscription service.

8. A system having at least one processor storage, and a communication platform for content recommendation, the system comprising:
a data mining module configured to determine a topic of interest based on a user's online activities and obtain a profile of the user;
a clustering module configured to generate a cluster of topics based on the determined topic of interest and the profile of the user and determine an overall topic of the cluster of topics and at least one of the one or more neighbor topics, wherein the cluster of topics include the determined topic of interest and one or more neighbor topics that share a common theme with the determined topic of interest; and
a recommendation module configured to provide content recommendation to the user including a first piece of content related to the overall topic and a second piece of content related to the at least one neighbor topic.

9. The system of claim 8, wherein at least one of the first and second pieces of content is determined based, at least in part, on locality of the user.

10. The system of claim 8, wherein
the profile of the user comprises the user's knowledge level with respect to the determined topic of interest; and
a granularity of the cluster of topics is adjusted based, at least in part, on the user's knowledge level with respect to the determined topic of interest.

11. The system of claim 10, wherein the user's knowledge level with respect to the determined topic of interest is determined based on prior searching activities of the user.

12. The system of claim 8, wherein
the cluster of topics are arranged in a hierarchy;
the overall topic of the cluster is determined by traversing up the hierarchy from the determined topic of interest; and
the at least one neighbor topic is determined by traversing up and traversing down the hierarchy from the determined topic of interest.

13. The system of claim 8, wherein the content recommendation is provided to the user through a social network.

14. The system of claim 8, wherein the content recommendation is provided to the user as a subscription service.

15. A non-transitory machine-readable medium having information recorded thereon for content recommendation, wherein the information, when read by the machine, causes the machine to perform the following:
determining a topic of interest based on a user's online activities;
obtaining a profile of the user;
generating a cluster of topics based on the determined topic of interest and the profile of the user, wherein the cluster of topics include the determined topic of interest and one or more neighbor topics that share a common theme with the determined topic of interest;
determining an overall topic of the cluster of topics and at least one of the one or more neighbor topics; and
providing content recommendation to the user including a first piece of content related to the overall topic and a second piece of content related to the at least one neighbor topic.

16. The medium of claim 15, wherein at least one of the first and second pieces of content is determined based, at least in part, on locality of the user.

17. The medium of claim 15, wherein
the profile of the user comprises the user's knowledge level with respect to the determined topic of interest; and
a granularity of the cluster of topics is adjusted based, at least in part, on the user's knowledge level with respect to the determined topic of interest.

18. The medium of claim 17, wherein the user's knowledge level with respect to the determined topic of interest is determined based on prior searching activities of the user.

19. The medium of claim 15, wherein
the cluster of topics are arranged in a hierarchy;
the overall topic of the cluster is determined by traversing up the hierarchy from the determined topic of interest; and
the at least one neighbor topic is determined by traversing up and traversing down the hierarchy from the determined topic of interest.

20. The medium of claim 15, wherein the content recommendation is provided to the user through a social network.
